(19) United States
(12) Patent Application Publication
(10) Pub. No.: US 2019/0147343 A1
(43) Pub. Date: May 16, 2019

(54) UNSUPERVISED ANOMALY DETECTION USING GENERATIVE ADVERSARIAL NETWORKS

(71) Applicant: International Business Machines Corporation, Armonk, NY (US)

(72) Inventors: GUY LEV, Tel Aviv (IL); Matan Ninio, Tel Aviv (IL); Oren Sar Shalom, Nes Ziona (IL)

(21) Appl. No.: 15/813,192

(22) Filed: Nov. 15, 2017

(51) Int. Cl. G06N 3/08; G06N 3/04; G06F 7/02; G06F 17/18

(52) U.S. Cl. CPC G06N 3/088; G06F 17/18; G06F 7/023; G06N 3/0445

(57) ABSTRACT

A method, system and computer program product, the method comprising: mutually training, using feedback, a generator and a discriminator of a conditional adversarial generative adversarial networks using training item groups, each item group representing events in a time window, the generator comprises a generator Recurrent Neural Network (RNN), the discriminator comprises a discriminator RNN; receiving by the discriminator, discrete sequential data comprising a sequence of item groups comprising an item group representing events in a time window, and item groups representing events in preceding time windows; altering the sequence of item groups into collections of real numbers and providing them to the discriminator RNN; processing the collections by the discriminator RNN to obtain a probability for the item group to comprise an anomaly, in an unsupervised manner; and providing output to a user, the output based on the probability and indicative of a label for the discrete sequential data.

### TECHNICAL FIELD

The present disclosure relates to anomaly detection in general, and to a method and apparatus detecting anomalies in sequential data using generative adversarial networks, in particular.

### BACKGROUND

In data mining, anomaly detection (also outlier detection) is the identification of items, events, observations or combinations of the above which do not conform to an expected pattern, to other items within a given input, or are otherwise exceptional.

Anomalous items can come from a real world problem such as bank fraud, a structural defect, a medical problem, an error in a text, or the like. Anomalies are sometime referred to as outliers, noise, deviations or exceptions.

An important field in which it is required to identify anomalies is computer system abuse, such as but not limited to network intrusion detection. Anomalous behaviors can be expressed as rare objects. However, in other situations times anomalous behaviors do not adhere to the common statistical definition of rare objects, but are rather expressed as out of context combinations which are unidentifiable by many traditional anomaly detection methods.

### BRIEF SUMMARY

One exemplary embodiment of the disclosed subject matter is a computer-implemented method comprising: mutually training, using a feedback loop, a generator component and a discriminator component of a conditional adversarial generative adversarial networks (GAN) using training item groups, wherein each item group represents events in a time window, wherein the generator component comprises a generator Recurrent Neural Network (RNN), wherein the discriminator component comprises a discriminator Recurrent Neural Network (RNN), wherein during training the generator component receives the training item groups and generates an artificial training item group, and the discriminator components receives the training item groups and an item group selected from the group consisting of the artificial training group and an additional training group, and determines whether the item group is the artificial training group or the additional training group; receiving by the discriminator component, discrete sequential data comprising a sequence of item groups, the sequence of item groups comprising an item group representing events in a specific time window, and item groups representing events in time windows preceding the time window; altering the sequence of item groups into collections of real numbers; providing the collections of real numbers to the discriminator RNN; processing the collections of real numbers by the discriminator RNN to obtain a probability for the item group to comprise an anomaly, in an unsupervised manner; and providing an output to a user, wherein the output is based on the probability and is indicative of a label for the discrete sequential data.

Another exemplary embodiment of the disclosed subject matter is a system having a processor, the processor being adapted to perform the steps of: mutually training, using a feedback loop, a generator component and a discriminator component of a conditional adversarial generative adversarial networks (GAN) using training item groups, wherein each item group represents events in a time window, wherein the generator component comprises a generator Recurrent Neural Network (RNN), wherein the discriminator component comprises a discriminator Recurrent Neural Network (RNN), wherein during training the generator component receives the training item groups and generates an artificial training item group, and the discriminator components receives the training item groups and an item group selected from the group consisting of the artificial training group and an additional training group, and determines whether the item group is the artificial training group or the additional training group; receiving by the discriminator component, discrete sequential data comprising a sequence of item groups, the sequence of item groups comprising an item group representing events in a specific time window, and item groups representing events in time windows preceding the time window; altering the sequence of item groups into collections of real numbers; providing the collections of real numbers to the discriminator RNN; processing the collections of real numbers by the discriminator RNN to obtain a probability for the item group to comprise an anomaly, in an unsupervised manner; and providing an output to a user, wherein the output is based on the probability and is indicative of a label for the discrete sequential data.

Yet another exemplary embodiment of the disclosed subject matter is a computer program product comprising a non-transitory computer readable medium retaining program instructions, which instructions when read by a processor, cause the processor to perform a method comprising: mutually training, using a feedback loop, a generator component and a discriminator component of a conditional adversarial generative adversarial networks (GAN) using training item groups, wherein each item group represents events in a time window, wherein the generator component comprises a generator Recurrent Neural Network (RNN), wherein the discriminator component comprises a discriminator Recurrent Neural Network (RNN), wherein during training the generator component receives the training item groups and generates an artificial training item group, and the discriminator components receives the training item groups and an item group selected from the group consisting of the artificial training group and an additional training group, and determines whether the item group is the artificial training group or the additional training group; receiving by the discriminator component, discrete sequential data comprising a sequence of item groups, the sequence of item groups comprising an item group representing events in a specific time window, and item groups representing events in time windows preceding the time window; altering the sequence of item groups into collections of real numbers; providing the collections of real numbers to the discriminator RNN; processing the collections of real numbers by the discriminator RNN to obtain a probability for the item group to comprise an anomaly, in an unsupervised manner; and providing an output to a user, wherein the output is based on the probability and is indicative of a label for the discrete sequential data.

### THE BRIEF DESCRIPTION OF THE SEVERAL VIEWS OF THE DRAWINGS

The present disclosed subject matter will be understood and appreciated more fully from the following detailed description taken in conjunction with the drawings in which corresponding or like numerals or characters indicate corresponding or like components. Unless indicated otherwise, the drawings provide exemplary embodiments or aspects of the disclosure and do not limit the scope of the disclosure. In the drawings:

FIG. 1 shows a flowchart diagram of a method of anomaly detection, in accordance with some exemplary embodiments of the disclosed subject matter;

FIG. 2 shows an illustrated example of training the generator and discriminator, in accordance with some exemplary embodiments of the disclosed subject matter;

FIG. 3 shows an illustrated example of utilizing the discriminator, in accordance with some exemplary embodiments of the disclosed subject matter; and

FIG. 4 shows a block diagram of a computing device configured for generating testing models, in accordance with some exemplary embodiments of the disclosed subject matter.

### DETAILED DESCRIPTION

Generative adversarial networks (GANs) are a type of artificial intelligence algorithms used for unsupervised machine learning. A GAN may consist of two units, each implemented as a neural network, wherein the two networks contest against each other and thus train each other. During training one network is referred to as a generator, and its task is to receive input and generate output that seems to imitate the characteristics of the input. The other network is referred to as a discriminator, and its task is to receive the same input as received by the generator, and an additional input, which may be either from the same source as the input received by the generator, or the output generated by the generator. The discriminator then needs to determine whether the additional input is obtained from the same source as the input, i.e., it represents normal input, or is generated by the generator, i.e., represents an anomaly.

The decision of the discriminator is then fed back to the generator, which can thus be trained and improve the output quality, such that the discriminator is less successful in making a correct determination on further activations.

Thus, the generator and the discriminator challenge each other, such that if one of them is significantly better than the other (for example the discriminator is better and makes the correct determination with high probability, or the generator is better and the discriminator is mostly wrong), the GAN is of little use. The goal, being a discriminator that provides high performance on real data can be achieved only if the two components challenge and assist each other in improving.

In some exemplary uses, anomalies in the data are rare. Therefore, data generated by the generator that does not comply with the distribution of the input data can be considered an anomaly.

Identifying an anomaly is a complex task, in particular when a sequence of items is received, wherein each item may be legitimate in itself, and it is required to identify a sequence of items which is anomalous within the context of the received input. An important example for such need is a requirement to identify a message or a sequence of message exchanged within a computer system or a computer network in response to an intrusion, intrusion attempt, virus or another threat. This task is extremely complex due to the large number of message exchanged, wherein the messages are typically of predetermined types.

Thus, one technical problem is receiving a stream of messages exchanged within a computer system or network, and identifying whether the stream comprises an anomaly, wherein the anomaly may be the result of a problem such as an intrusion, intrusion attempt, virus, or the like.

One technical solution comprises splitting one or more training streams into time windows, and for each time window indicating the number of messages of each type transmitted during the time window, for example in a histogram structure. The data for the given time windows is then fed into a generator component of a GAN, and the RNN of the generator generates data of the same type, for example another histogram.

The data for the given time windows, as well as additional data which may represent the messages transmitted during a further time window, or the data generated by the generator, may then be fed into the discriminator of the GAN. The discriminator then needs to determine whether the additional data is genuine, i.e., represents messages transmitted during the further time window or generated by the generator. The discriminator and the generator then receive feedback indicating whether the decision taken by the discriminator was correct or not.

One technical effect of the disclosure is the provisioning of an unsupervised system and method for detecting anomalies in a sequence of messages transmitted in a computer system or network.

Another technical effect the disclosure relates to the discriminator providing a probability of normal/abnormal for the whole sequence, rather than a probability for every possible message type. Traditional systems, on the contrary, may provide a probability for each message type to be expected or unexpected, which may thus be translated to normal or abnormal behavior. For example, if there are one hundred and one possible message types, wherein one hundred of them represent normal message types and each is assigned a probability of 1/100, and one is abnormal and is assigned a probability of 0, then if a message of one of the normal types is detected, this is an event of probability 1/100, which may be considered low and thus determined to be abnormal. A more severe situation may occur with 1000, 10,000 message types, or the like. A solution in accordance with the disclosure, however, provides a probability for the whole sequence of events, represented for example as an histogram to be abnormal, without the user having to define abnormality.

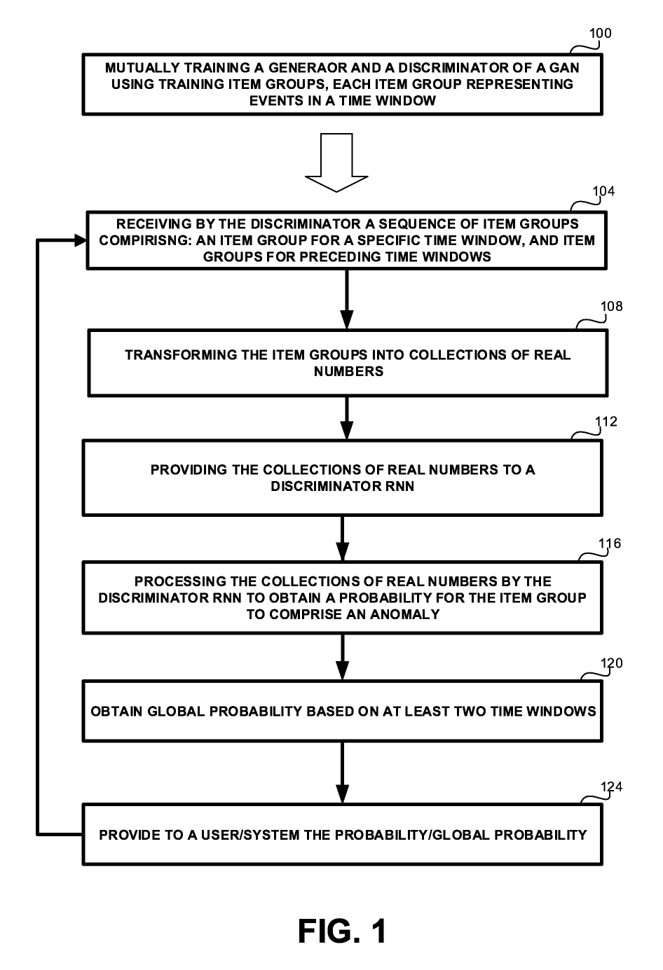

Referring now to FIG. 1, showing a flowchart of steps in a method for anomaly detection in accordance with the disclosure.

On step 100, a generator and discriminator of a generative adversarial network can be mutually trained. Although as detailed below, in runtime only the discriminator is used, it is still required to train also the generator so that they mutually train each other, otherwise the discriminator is not trained well enough and can only determine whether the training data is provided by the generator or not, and will not be useful for real world data.

The input to the generator and discriminator is comprised of integer numbers (occurrences numbers), while the generator may output real numbers. Thus, upon receiving real numbers, the discriminator can immediately determine that the input is from the generator and not genuine. In order to eliminate this problem, the input to the generator and to the discriminator may be transformed into real numbers, for example by adding, multiplying or performing any another operation involving random noise, such as a multivariate Gaussian noise.

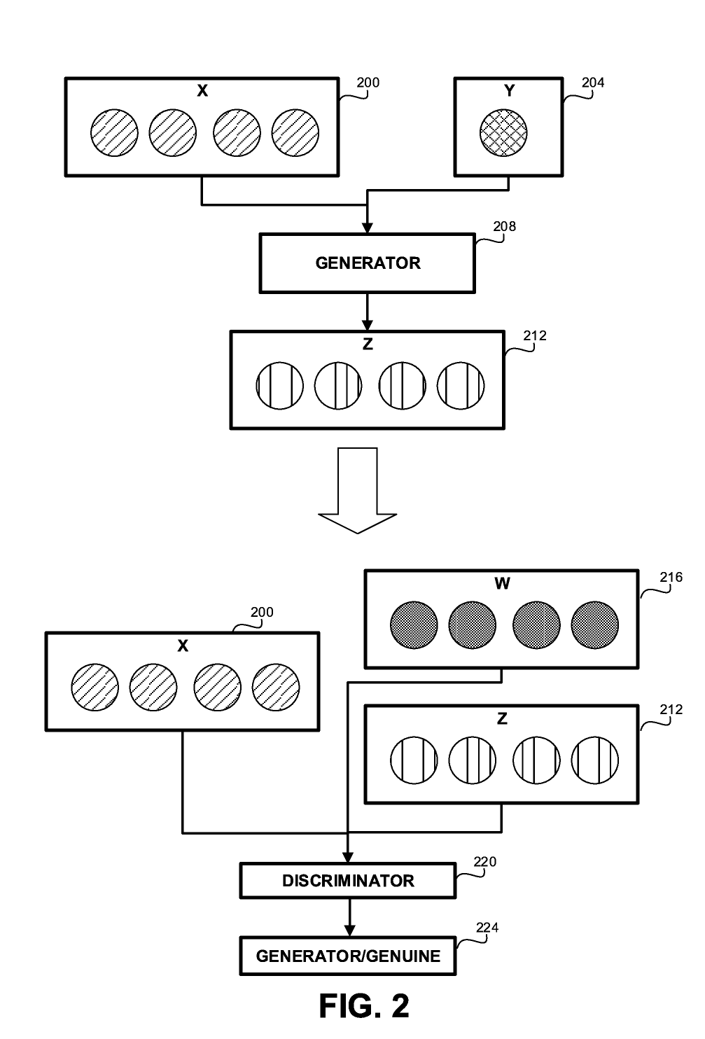

Referring now also to FIG. 2, showing an illustrated example of training the generator and discriminator.

Generator 208 and discriminator 220 are trained using real world data X (200), and in particular data comprising messages transmitted during a sequence of time windows within a system which needs to be monitored. For example, the data may include the distribution of message types within consecutive time windows, such as time windows of 1 second, 10 seconds, one minute, five minutes, one hour, or the like. Exemplary data may include: time window, number of messages of type 1, number of messages of type 2, etc. Alternatively, the data may include the time window and a sequence of message types in their order of transmittance. Generator 208 receives data X (200) related to a predetermined number of time windows and additional data Y (204) such as a random seed to be fed to the neural network, and attempts to generate artificial data Z (212) which represents data that could have been captured on another time window. Discriminator 220 gets the same input data X (200) related to the predetermined number of time windows, and additional data which may be either artificial data Z (212) of the generator, or real data W (216) for the following time window, and needs to output 224 whether the additional data is the artificial data generated by generator 208 or is genuine data 216.

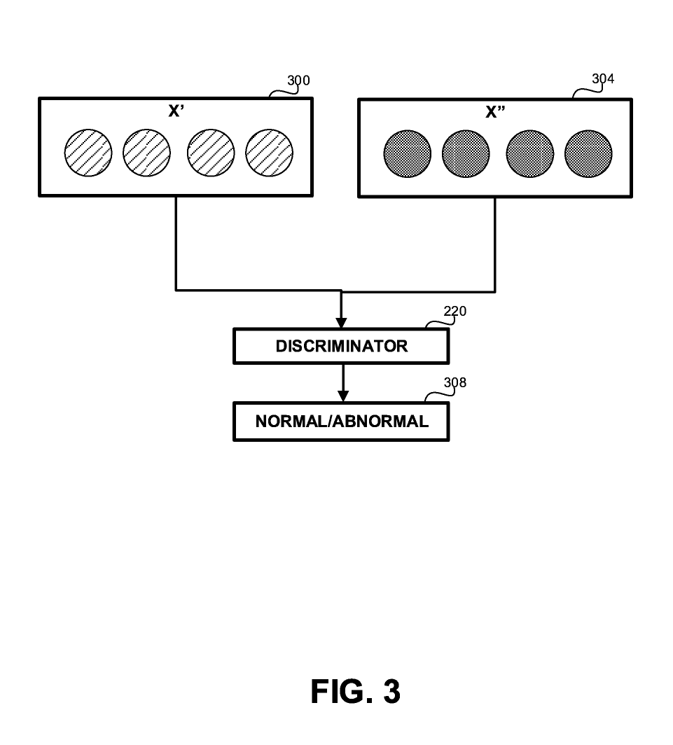

Referring now also to FIG. 3, showing an illustrated example of utilizing discriminator 220.

Discriminator 220 receives data X′ (300) related to preceding time windows. The data may be received, as detailed above, in the form of a histogram representing the number of appearances per message type in each time window.

Discriminator 220 also receives data X″ (304) related to a current time window, for which it is required to determine 308 whether it comprises an anomaly or not. The determination is detailed in association with the steps below.

On step 104 of FIG. 1, once generator 208 and discriminator 220 are trained, discriminator 220 can receive item groups, comprising one item group representing messages exchanged during a time window for which it is required to determine whether it contains an anomaly, and other item groups representing messages exchanged during time windows preceding the time window.

The item groups as received may comprise discrete numbers such as integers, since each item group represents the number of messages of each type during a time window. However, as detailed above, the discriminator as trained expects real numbers. Therefore, on step 108, the item groups are transformed into groups of real numbers, for example by adding, multiplying or performing another operation with random noise, such as a multivariate Gaussian noise. It will be appreciated that step 108 can be performed prior to providing the numbers to the discriminator; by the generator/discriminator prior to providing the numbers to the RNN as detailed below; or by the RNN.

On step 112, the collections of real numbers can be provided to the discriminator RNN.

On step 116, the discriminator RNN can process the collections of real numbers, including those associated with previous time windows and the one associated with the current time window, to obtain a probability of the input to comprise an anomaly. In accordance with the training, the discriminator actually provides the probability that the input is artificially generated and not actual collected data. However, data determined which the discriminator indicates as being artificially generated is interpreted an anomaly.

It will be appreciated that the assessment is for an anomaly to exist, without the user having to define an anomaly. Prior art solutions, however, provide a probability for each event, such as a probability that the next message will be of a particular type, that a specific messages type combination is received, or the like. Thus, with prior art solutions, it is not the probability of an anomaly that is output but only of specific events, and the user, or another system, has to decide whether any event is anomalous or not. In a solution in accordance with the disclosure, however, a user is not required to define for each event whether it is normal or abnormal, but rather receives a probability that an anomaly has been detected.

On step 120, a further and more global probability may be obtained, in which a probability of an abnormal situation may be assessed based on the abnormality probabilities combination for a multiplicity of time windows. For example, a global abnormal situation may be assigned a high probability upon abnormal situation having a probability exceeding a threshold for at least a predetermined number of consecutive time windows, abnormal situation having a probability exceeding a threshold in at least a predetermined number of time windows within a sequence of at most a predetermined number of time windows, for example at least 5 indications for abnormal situation having a probability exceeding 50% within at most 20 consecutive time windows, or the like.

On step 124, output based on the global probability, or on the probability if step 120 is not performed, obtained in an unsupervised manner, may be provided, for example to a user, to a log file, to a computerized system, to a system that may invoke steps such as halting communication if the assessment is of abnormality, or the like. The output is thus indicative of a label for the discrete sequential data, for example normal or abnormal. In some embodiments, any assessment may be provided, while in other embodiments, only assessments indicating an anomaly with a probability exceeding a threshold may be provided.

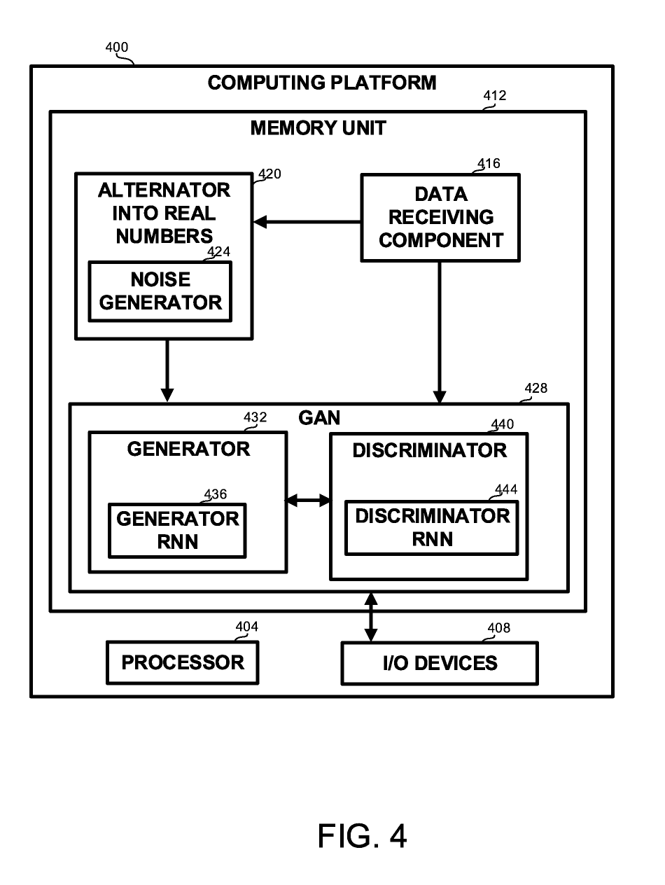

Referring now to FIG. 4, showing a block diagram of a computing platform, in accordance with some exemplary embodiments of the disclosed subject matter.

A computing platform 400 depicted in FIG. 4, may be configured to provide an assessment for normality or abnormality of sequential data.

In some exemplary embodiments computing platform 400 may comprise a processor 404, which may be a Central Processing Unit (CPU), a microprocessor, an electronic circuit, an Integrated Circuit (IC) or the like. Processor 404 may be utilized to perform computations required by computing platform 400 or any of it subcomponents. Processor 404 may be configured to execute computer-programs useful in performing the method of FIG. 1.

In some exemplary embodiments, one or more I/O devices 408 may be configured to receive input from and provide output. In some exemplary embodiments, I/O devices 408 may be utilized to present or otherwise provide an indication for normality/abnormality of part of the data in view of the other data. I/O devices 408 may also be utilized to obtain user input instructions for example setting the duration of each time window, or the like.

In some exemplary embodiments, a memory unit 412 may be a short-term storage device or long-term storage device. Memory unit 412 may be a persistent storage or volatile storage. Memory unit 412 may be a disk drive, a Flash disk, a Random Access Memory (RAM), a memory chip, or the like. In some exemplary embodiments, memory unit 412 may retain program code operative to cause processor 404 to perform acts associated with any of the subcomponents of computing platform 400. In some exemplary embodiments, memory unit 412 may retain program code operative to cause processor 404 to perform acts associated with any of the steps shown in FIG. 1 above.

The components detailed below may be implemented as one or more sets of interrelated computer instructions, executed for example by processor 404 or by another processor. The components may be arranged as one or more executable files, dynamic libraries, static libraries, methods, functions, services, or the like, programmed in any programming language and under any computing environment.

Memory unit 412 may retain data receiving component 416 for receiving data, such as a log of messages transmitted to or within a computer system or network.

Memory unit 412 may retain alternator to real numbers 420, configured for receiving one or more sequences of integer numbers, and altering them into sequences of real numbers, for example by utilizing a multivariate Gaussian noise 424.

Memory unit 412 may retain GAN 428, comprising generator 432 having generator RNN 436 and discriminator 440 having discriminator RNN 444.

It will be appreciated that generator 432 and discriminator component 440 can be trained together, for example in a central IT lab, after which a multiplicity of users, such as IT managers within an organization may receive a system in accordance with the disclosure, but without generator 432, since no more training is required. Discriminator 440 may be updated periodically or upon need and re-distributed to the users.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A computer-implemented method, comprising:
mutually training, using a feedback loop, a generator component and a discriminator component of a conditional adversarial generative adversarial networks (GAN) using training item groups, wherein each item group represents events in a time window, wherein the generator component comprises a generator Recurrent Neural Network (RNN), wherein the discriminator component comprises a discriminator Recurrent Neural Network (RNN), wherein during training the generator component receives the training item groups and generates an artificial training item group, and the discriminator components receives the training item groups and an item group selected from the group consisting of the artificial training group and an additional training group, and determines whether the item group is the artificial training group or the additional training group;
receiving by the discriminator component, discrete sequential data comprising a sequence of item groups, the sequence of item groups comprising an item group representing events in a specific time window, and item groups representing events in time windows preceding the time window;
altering the sequence of item groups into collections of real numbers;
providing the collections of real numbers to the discriminator RNN;
processing the collections of real numbers by the discriminator RNN to obtain a probability for the item group to comprise an anomaly, in an unsupervised manner; and
providing an output to a user, wherein the output is based on the probability and is indicative of a label for the discrete sequential data.

2. The computer-implemented method of claim 1, wherein said providing the output comprises computing a global probability, wherein the global probability is based at least two probabilities assigned to at least two time windows, wherein the output is based on the global probability.

3. The computer-implemented method of claim 1, wherein each item group representation comprises a histogram of event types of events occurring in a respective time window.

4. The computer-implemented method of claim 1, wherein said altering the item group into collections of real numbers comprises combining the item group with a multivariate Gaussian noise.

5. The computer-implemented method of claim 1, wherein at least two time windows of the specific time window and the time windows overlap.

6. A system having a processor, the processor being adapted to perform the steps of:
mutually training, using a feedback loop, a generator component and a discriminator component of a conditional adversarial generative adversarial networks (GAN) using training item groups, wherein each item group represents events in a time window, wherein the generator component comprises a generator Recurrent Neural Network (RNN), wherein the discriminator component comprises a discriminator Recurrent Neural Network (RNN), wherein during training the generator component receives the training item groups and generates an artificial training item group, and the discriminator components receives the training item groups and an item group selected from the group consisting of the artificial training group and an additional training group, and determines whether the item group is the artificial training group or the additional training group;
receiving by the discriminator component, discrete sequential data comprising a sequence of item groups, the sequence of item groups comprising an item group representing events in a specific time window, and item groups representing events in time windows preceding the time window;
altering the sequence of item groups into collections of real numbers;
providing the collections of real numbers to the discriminator RNN;
processing the collections of real numbers by the discriminator RNN to obtain a probability for the item group to comprise an anomaly, in an unsupervised manner; and
providing an output to a user, wherein the output is based on the probability and is indicative of a label for the discrete sequential data.

7. The system claim 6, wherein said providing the output comprises computing a global probability, wherein the global probability is based at least two probabilities assigned to at least two time windows, wherein the output is based on the global probability.

8. The system of claim 6, wherein each item group representation comprises a histogram of event types of events occurring in a respective time window.

9. The system of claim 6, wherein said altering the item group into collections of real numbers comprises combining the item group with a multivariate Gaussian noise.

10. The system of claim 6, wherein at least two time windows of the specific time window and the time windows overlap.

11. A computer program product comprising a non-transitory computer readable medium retaining program instructions, which instructions when read by a processor, cause the processor to perform a method comprising:
mutually training, using a feedback loop, a generator component and a discriminator component of a conditional adversarial generative adversarial networks (GAN) using training item groups, wherein each item group represents events in a time window, wherein the generator component comprises a generator Recurrent Neural Network (RNN), wherein the discriminator component comprises a discriminator Recurrent Neural Network (RNN), wherein during training the generator component receives the training item groups and generates an artificial training item group, and the discriminator components receives the training item groups and an item group selected from the group consisting of the artificial training group and an additional training group, and determines whether the item group is the artificial training group or the additional training group;
receiving by the discriminator component, discrete sequential data comprising a sequence of item groups, the sequence of item groups comprising an item group representing events in a specific time window, and item groups representing events in time windows preceding the time window;
altering the sequence of item groups into collections of real numbers;
providing the collections of real numbers to the discriminator RNN;
processing the collections of real numbers by the discriminator RNN to obtain a probability for the item group to comprise an anomaly, in an unsupervised manner; and
providing an output to a user, wherein the output is based on the probability and is indicative of a label for the discrete sequential data.
